(19) United States
(12) Patent Application Publication
(10) Pub. No.: US 2009/0241845 A1
(43) Pub. Date: Oct. 1, 2009

(54) Digitally timed feeder and method of using same

(76) Inventor: Robert L. Croft, Hunt, TX (US)

Correspondence Address: THE MATTHEWS FIRM, 2000 BERING DRIVE, SUITE 700, HOUSTON, TX, 77057, US

(21) Appl. No.: 12/079,882

(22) Filed: Mar. 28, 2008

(51) Int. Cl. A01K 5/00

(52) U.S. Cl. 119/51.11; 119/57.1; 119/51.01

(57) ABSTRACT

A digitally programmable product dispenser having a motor operationally connected to a spinner wherein said product from a product hopper is distributed along a plurality of feed channels. The product distribution may be onto a spinner and the spinner distributes the product along a plurality of feed channels. The motor can be actuated, by a digital timer, programmed to run at predetermined intervals throughout the day, as well as operate for a predetermined amount of time, therefore, economically distributing the feed in position where more then one member of wildlife and/or livestock can be fed.

### TECHNICAL FIELD

This invention relates to apparatuses and methods for dispensing feed and other products to wildlife or livestock. More specifically, the present invention relates to dispersing feed in an efficient manner and a controllable cycle.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers.

FIG. 1 illustrates a top view of an embodiment of the feeder tray according to the present invention;

FIG. 2 illustrates side elevated view of the feeding tray and dispensing spinner according to the present invention; and

FIG. 3 illustrates a pictorial view of the invention mounted on an exemplary feed hopper.

### DETAILED DESCRIPTION OF EMBODIMENTS OF THE INVENTION

It is well known in the art that a variety of different feeders and methods for dispersing the feed has been available for both wildlife and livestock, including but not limited to animals, birds, etc. The hoppers vary from closed containers or drums to uncovered or semi-covered troughs and a variety of other containers that provide access to the various animals, livestock or wildlife. Further, the dispersing of the feed from the hopper has also varied from the use of spinners with low voltage power sources such as batteries to more sophisticated controls such as photoelectric cells, which may turn on the feeder at daylight or after dark, as well as, more straightforward methods such as simple holes in the bottom of the hopper that allow the feed to fall by gravity to open troughs or other open areas, in which, as soon as the feed is eaten more feed is drawn by gravity to replace it. However, the prior art does not provide for an efficient method to disperse the feed, as well as, control the feeding times. Further, many of the prior art devises are wasteful in that either too much feed or not enough feed is dispersed at one time. If there is too much feed, it can be eaten by other wildlife or birds for which it is not intended or it may simply ruin from exposure to the elements. Still further, some of these feeding systems can be easily damaged by the environment or by the wildlife or livestock that feeds from it. The art further needs a dispersal devise which can be attached to almost any hopper or feed dispersal system in order to allow adaptation of an efficient dispersal system to any existing or new hoppers.

It should be understood that although the embodiments described herein primarily refer to the dispensing of feed, those in the art can readily see that other products including, but not limited to, medication, seed, insecticide, herbicide, lime, etc. can be dispensed as well and should not be viewed as a limitation herein. Further wildlife and livestock, as used herein, includes, but is not limited to, domestic and wild animals, aquatic species, as well as other wild or cultivated plants and insects.

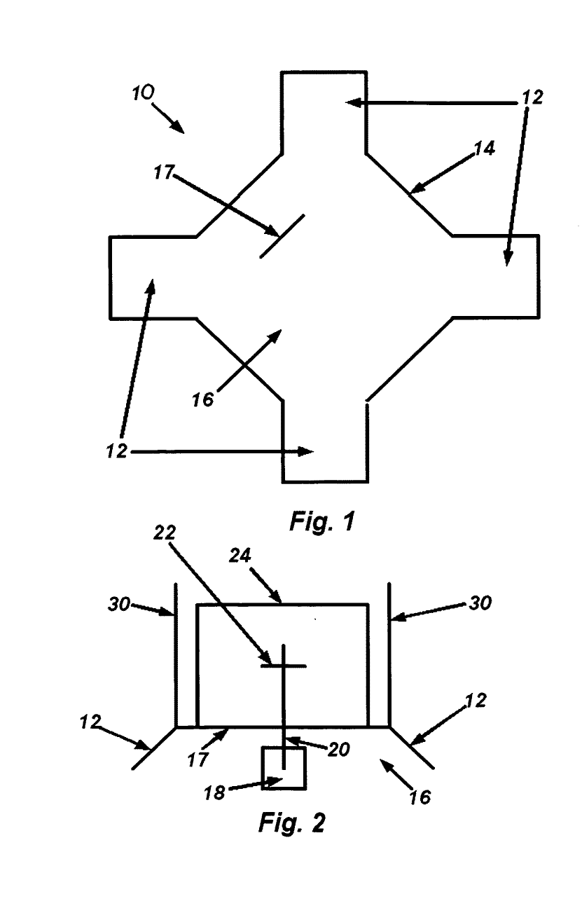

FIG. 1 illustrates an embodiment of digitally timed feeder 10. Preferably this feeder 10 embodiment has at least four feeding tubes 12. However, it should be appreciated that the number of feeding tubes 12 is entirely dependent upon the preferred use of the feeder and how many dispersal tubes or mechanisms are desired to spread the feed or other product throughout the tray or trough 42 depending particularly upon the type and number of wildlife or livestock that is being fed. The feeding tubes 12 may be rectangular tubing, circular tubing or I-beam shaped. Again it should be appreciated that the cross section shape of the tube 12 should not be viewed as a limitation herein as the choice of cross sectional shapes may depend on factors, such as but not limited to, price and availability of materials. It should be further appreciated that the feeding tubes 12 may be conventionally available steel channel or may be of other materials and/or other light weight construction materials, such as but not limited to, fiberglass, plastic, various composites, metals, or any combination thereof. Preferably, the feeding tubes 12 are attached together as illustrated in FIG. 1 at one end of the feeding tube. It is preferable to join the four feeding tubes 12 in such a manner as to form a feeder tray 16. One method of such joining, as illustrated in FIG. 1, is to place the tubes and join them together with a plate section 17 so as to form a substantially octagonal shaped tray 16.

The plate section 17 should preferably include walls 14. Walls 14 can either be an integral part of plate 17 that is bent or shaped from the plate or can be additional pieces of material added to the plate 17. Again it should be understood that the shape of the tray should in no way be a limitation herein as those skilled in the fabrication art would quickly realize the many different configurations that could be had in connecting feeder tubes 12 together. The feeder tray 16 is thus, preferably formed by the bottom plate 17, the walls 14, which extend between the feeder pipes and are preferably the same height as the feeder tube 12 walls, and the feeder tubes 12. It is preferred that the plate 17 and the walls 14 form the tray 16 so as to prevent feed or other product from falling from the bottom of tray 16. It should be understood that the methods of attaching feeding tubes 12 so as to form tray 16 as well as the attachment of plate 17 to form tray 16 would be a matter of practice. Those skilled in the art would readily appreciate that if the parts are metallic they can be joined by welding or bracing and whether they are metallic or not they could be joined through a series of bolts, rivets, screws and the like. It should be understood that the method of joining feeding tubes 12 to form tray 16 should not be viewed as a limitation herein.

FIG. 2 illustrates a side view of tray 16. Preferably, tray 16 is also covered by plate 24. Plate 24 could be a formed plate or a formed structure designed to restrict the feed flow into tray 16. Thus plate 24 may comprise manual or slide openings (not shown), it may comprise a series of holes to allow the feeder to feed in by gravity or vibration, or it may contain permanent holes with the addition of some type of restriction plate such as a rotating plate (manual or automatic) or other restricting orifice which would allow only the certain size of feed or no feed to pass through plate 24 into tray 16. Preferably, there is motor 18 mounted below tray 16 with a shaft 20 passing through plate 17. It should be appreciated that motor 18 maybe any variety of conventional motors including, but not limited to, blower motors. Preferably motor 18 is a digitally controlled motor having a controller therein, which can be programmed so as to control the operation of motor 18. The advantage of the digital motor 18 is to provided better and more precise control of the feeding cycles. Therefore, motor 18 may be actuated by a programmable digital or analog timer to run for some predetermined time, such as, 10 seconds, 20 seconds, 30 seconds, etc. and at a variety of times during the day, such as, 3 times a day, 4 times a day, 6 times a day, etc. It should be understood that the exact duration of motor operation, as well as, the number of feedings or number of operations per day would be dependent on facts, such as but not limited to, the amount of wildlife or livestock to be fed, the type of wildlife or livestock to be fed, the time of year and feeding habits of the wildlife or livestock, as well as a variety of other feeding factors. It should be further understood, that other motors 18 may be used and as such it would be preferable to have a local controller (not illustrated) so as to allow the programming of the motor operation including cycle duration as well as number of cycles.

For product dispersal a spinner 22 or a blower motor my be used. Preferably mounted on motor shaft 20 is a spinner 22. It should be understood that if a blower motor is utilized, a spinner may not be necessary for the product dispersal. Spinner 22 maybe of a variety of shapes, such as but limited to, a triangular spinner, a multi arm spinner, or any variety of conventional or specially made spinner. The type of spinner 22 mounted on motor shaft 20 should not be viewed as a limitation herein, as those skilled in the art would be able to purchase a variety of conventional spinners as well as modify or fabricate their own spinners. One of the purposes of spinners 22 is to allow any grain, feed, etc. to be substantially evenly distributed among the feeding tubes 12. Preferably, the substantially uniform distribution of feed is accomplished by regulating the size or the number of orifices in the restriction plate or in plate 24 so as to keep an even flow of feed while the spinner is spinning and distributing the feed to the feeding tubes 12. It should be appreciated that the amount of feed passing through plate 24 to the spinner 22 can be based on factors such as but not limited the size of the individual grains of feed. Preferably, tray 22 and/or the feeding tubes 12 are fitted with mounting brackets 30. Mounting brackets 30 maybe any variety of conventional mounting bracket and materials, including metallic, non metallic, and any combination thereof, which will resist the environmental conditions to which the brackets will be exposed. Further, it should be appreciated that brackets 30 maybe attached directly to tray 16 or to the feeding tubes 12. The purpose of the mounting brackets 30 are to mount the feeder 10 to substantially any type of hopper containing the grain or feed.

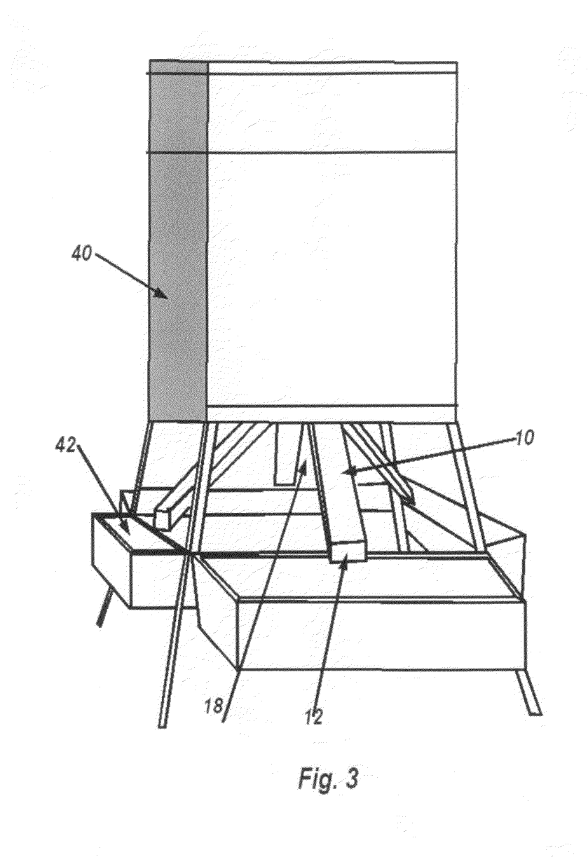

FIG. 3 illustrates a pictorial view of an embodiment of the feeder 10 attached to a typical feed hopper 40. In this embodiment the feed hopper 40 has a tray or trough 42, which allows wildlife or livestock to feed from a variety of positions. However, it should be understood that the feeder tubes 12 can feed any number of trays or troughs, as well as, provide feed to the ground or any other desired place.

In operation, the feeder 10 is preferably attached, to the hopper 40, through mounting brackets 30 (FIG. 2) or other adapted mounting system. The hopper 40 may be any type of feed hopper having a discharge port which can be aligned with the feeder 10. The hopper 40 is filled with the appropriate grain or feed as is applicable to the wildlife or livestock to be fed. Motor 18 is then programmed for a desired cycle duration and the desired number of cycles per day. It should be appreciated that the combination of cycle duration and number of cycles will disperse a more efficient amount of feed such that the food is eaten when dispersed or shortly thereafter and is not wasted or picked through by any scavengers. It should be further appreciated that the cycle duration may also be varied according to the times that the target wildlife or livestock will be eating larger or smaller amounts.

It will be understood that certain features and sub-combinations are of utility and may be employed without reference to other features and sub-combinations. This is contemplated by and is within the scope of the claims. It may be seen from the preceding description that a novel digitally timed feeder system has been provided. Although specific examples may have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. A feed dispensing apparatus comprising:
a plurality of feeder tubes, each feeder tube having a first end and a second end, wherein said first end of each feeder tube is joined to a plate so as to form a tray having a top side and a bottom side, and wherein said top side of said tray is in communication with said plurality of feeder tubes, and wherein said tray receives feed from a feed hopper;
a cover, said cover at least partially enclosing said tray;
a motor having at least one output shaft, said output shaft passing through said tray; and
a spinner, wherein said spinner is at least partially enclosed within said cover, and wherein said spinner is in communication with the output shaft of the motor, and wherein said spinner moves the feed from the tray to the plurality of feeder tubes in response to rotation of said output shaft, and wherein said plurality of feeder tubes dispenses said feed to a feeding area.

2. The feed dispensing apparatus of claim 1, wherein said cover defines at least one aperture, said aperture being selectively opened or closed to at least partially control a rate of dispensed feed.

3. The feed dispensing apparatus of claim 2, wherein said at least one aperture can pass protein pellets.

4. The feed dispensing apparatus of claim 1, wherein said motor is controlled by a programmable digital and/or analog timer.

5. The feed dispensing apparatus of claim 1, wherein said feeder tubes are rectangular channel or circular channeled.

6. The feed dispensing apparatus of claim 1, wherein said spinner is a triangular three way spinner.

7. The feed dispensing apparatus of claim 1, wherein said plurality of feeder tubes further comprises at least four feeder tubes.

8. The feed dispensing apparatus of claim 1, wherein said motor can operate for an interval of up to 30 seconds.

9. The feed dispensing apparatus of claim 1, wherein said motor can be actuated by a programmable digital timer set for a pre-determined time interval.

10. The feed dispensing apparatus of claim 1, wherein said motor can be operated up to six times per day.

11. The feed dispensing apparatus of claim 1, wherein said motor can be actuated by a digital timer to operate a pre-determined number of times per day.

12. A method of using a timed feeder for wildlife or livestock comprising the steps of:
providing a feeding apparatus comprising a plurality of feeder tubes, a motor having at least one output shaft, and a spinner, wherein said spinner is capable of receiving and distributing feed into said plurality of feeder tubes;
connecting the feeder assembly, wherein said feeder assembly accepts feed from a feed container;
programming said motor, wherein said motor operates a predetermined amount of time;
further programming said motor, wherein said motor operates a predetermined number of times per day;
distributing said feed, wherein said feeder container channels feed onto said spinner, and wherein said spinner channels feed into said plurality of feeding tubes.

13. The method of claim 12, wherein said motor is actuated by a digital timer programmable for operational time and duration.

14. The method of claim 12, wherein said use of feeder further comprises allowing wildlife or livestock to feed from more than one direction.

15. The method of claim 12, wherein said feeder motor is a 12-volt motor.

16. The method of claim 12, wherein said feeder motor is a 6 volt motor.

17. A product dispensing apparatus comprising:
a plurality of feeder tubes, each feeder tube having a first end and a second end, wherein said first end of each feeder tube is joined to a plate so as to form a tray having a top side and a bottom side, and wherein said top side of said tray is in communication with said plurality of feeder tubes, and wherein said tray receives product from a product hopper;
a cover, said cover at least partially enclosing said tray;
a motor, said motor moving the product from the tray to the plurality of feeder tubes in response to actuation of said motor, wherein said plurality of feeder tubes dispenses said product to a desired area.

18. The product dispensing apparatus of claim 17, wherein said motor further comprises at least one output shaft, said output shaft passing through said tray.

19. The product dispensing apparatus of claim 18, further comprising a spinner, wherein said spinner is at least partially enclosed within said cover, and wherein said spinner is in communication with the output shaft of the motor, and wherein said spinner moves the product from the tray to the plurality of feeder tubes in response to rotation of said output shaft, and wherein said plurality of feeder tubes dispenses said product to a desired area.

20. The product dispensing apparatus of claim 17, wherein said motor is controlled by a programmable digital and/or analog timer.

21. The product dispensing apparatus of claim 17, wherein said motor is a blower motor.
